(19) United States
(12) Patent Application Publication
(10) Pub. No.: US 2015/0075434 A1
(43) Pub. Date: Mar. 19, 2015

(54) LIP MEMBER, A TEATCUP LINER AND A TEATCUP

(71) Applicant: DELAVAL HOLDING AB, Tumba (SE)

(72) Inventor: Anneli Lidmar, Huddinge (SE)

(73) Assignee: DELAVAL HOLDING AB, Tumba (SE)

(21) Appl. No.: 14/389,771

(22) PCT Filed: Mar. 15, 2013
(86) PCT No.: PCT/SE2013/050286

§ 371 Date: Oct. 1, 2014

Related U.S. Application Data
(60) Provisional application No. 61/625,762, filed on Apr. 18, 2012.

(30) Foreign Application Priority Data
Apr. 18, 2012 (SE) 1250385-0

(51) Int. Cl. A01J 5/00

(52) U.S. Cl. CPC A01J 5/00
USPC 119/14.5

(57) ABSTRACT

A lip member of a teatcup liner for a teatcup includes a first end (3a) turned towards an udder of an animal to be milked; a second end (3b) turned away from the udder; a longitudinal center axis (x) extending through the first end and the second end; an annular base (60) extending around the longitudinal center axis; and a lip (61) with a lip edge (62) defining an opening for receiving a teat of the animal, the lip extending inwardly from the annular base towards the longitudinal center axis to the lip edge and having an oscillating shape with a plurality of oscillations seen radially from the longitudinal center axis, each oscillation including a peak portion (63) and valley portion (64), where the lip, at least in the rest state, slopes from the annular base towards the second end.

### TECHNICAL FIELD OF THE INVENTION

The present invention refers to a lip member configured to be comprised by a teatcup liner of a teatcup, as an integrated or separate part of the teatcup liner. More precisely, the present invention refers to a lip member according to the preamble of claim 1. The present invention also refers to a teatcup liner comprising a lip member, and to a teatcup.

### BACKGROUND OF THE INVENTION AND PRIOR ART

During the application of the teatcup liner to a teat, during milking and during the removal of the teatcup liner from the teat, the lip of the teatcup liner is subjected to deformation. The deformation is due to setting of the lip material, and the setting is due to a high stress that is built up in the lip material. After a certain time and use of the teatcup liner, the deformation may be permanent, and thus the ability to close tightly around the teat is reduced or get lost. In other words the deformation causes the teatcup liner to slip, i.e. to take in air. The deformation will therefore have a negative impact on the milking performance.

This problem is especially accentuated in connection with the use of new plastic materials in the teatcup liner, such as thermo-plastic elastomers, TPE, or thermo-plastic vulcanisates, TPV.

GB-1313457 discloses a lip member for a teatcup liner. The lip member comprise a first end, configured to be turned towards an udder of an animal to be milked, a second end, configured to be turned away from the udder, and a longitudinal centre axis extending through the first end and through the second end. An annular base extends around the centre axis. A lip comprises a lip edge defining an opening for receiving a teat of the animal to be milked. The lip extends in mounted rest state inwardly and upwardly from the annular base towards the centre axis to the lip edge. The lip has an oscillating shape with a plurality of oscillations seen radially from the centre axis. Each oscillation comprises a peak portion and valley portion.

U.S. Pat. No. 3,898,790 discloses a similar lip member for a teatcup. In this case the oscillations follow a spiral path on top of the lip member seen along the centre axis.

U.S. Pat. No. 8,028,656 discloses a teatcup liner made of various materials, such as thermo-plastic elastomers, TPE, or thermo-plastic vulcanisates, TPV.

### SUMMARY OF THE INVENTION

The object of the present invention is to overcome the problems discussed above and to provide an improved lip member configured to be comprised by a teatcup liner. More specifically, the object is to provide a lip member having a design permitting low stresses in the lip during use of the lip member, and permitting a uniform distribution of the stresses.

This object is achieved by the lip member initially defined, which is characterised in that the lip slopes from the annular base towards the second end at least in the mounted rest state.

Thanks to the oscillations, or wave-shape, the stretching and the deformation of the lip, especially in the proximity of the lip edge, is significantly reduced in comparison with a lip without oscillations during use of the lip member. The oscillations therefore contribute to a longer lifetime of the lip member since the stresses during use will be less. The sloping of the lip towards the second end also contributes to less deformation and less stretching of the lip, especially in the proximity of the lip edge. Since the lip is turned already in advance in the introductory direction for the teat, no great: deformation is needed, but only a straightening of the oscillations and a slight bending downwardly and outwardly. After milking when the udder is less tense, the teat may he easily and quickly removed from the teatcup liner through the opening of the lip member.

According to an embodiment of the invention, the oscillating shape comprises at least four oscillations, or waves, and at most seven oscillations, or waves. Such a number of oscillations ensures a tight abutment against the teat during milking. Preferably, the oscillating shape, or wave-shape, may comprise at least four oscillations, or waves, and at most six oscillations, or waves. More preferably, the oscillating shape may comprise at least four oscillations, or waves, and at most five oscillations, or waves.

According to a further embodiment of the invention, the amplitude of the oscillations decreases from the lip edge towards the annular base. Advantageously, the amplitude of the oscillations of the lip may be zero at the annular base.

According to a further embodiment of the invention, each peak portion and each valley portion extend in a radial direction when seen along the longitudinal centre axis.

According to a further embodiment of the invention, the annular base extends from the first end towards the second end.

According to a further embodiment of the invention, the lip member comprises an annular end surface provided on the annular base at the first end. Advantageously, the annular end surface may be plane, or substantially plane. The annular end surface may lie in an end plane being perpendicular, or substantially perpendicular, to the longitudinal centre axis. Such an annular end surface provides a suitable surface for applying the lip member and the teacup on a cleaning device. The annular end surface may abut tightly the support surface of the cleaning device, thereby ensuring an efficient cleaning of the teatcup and avoiding leakage of cleaning liquid during the cleaning operation.

According to a further embodiment of the invention, the lip extends from the annular base from a position between the first end and the second end. The lip will thus not interfere with the annular end surface.

According to a further embodiment of the invention, the lip edge is located at a position between the first end and the second end at least in the mounted rest state. Advantageously, each peak portion is located between the first end and the second end at least in the mounted rest state. Thus each peak portion may be completely located beneath the first end or the end plane.

According to a further embodiment of the invention, the annular base has a tubular shape between the first end and the second end.

According to a further embodiment of the invention, the lip and the annular base are manufactured of thermo-plastic elastomers, TPE, or thermo-plastic vulcanisates.

The object is also achieved by the teatcup liner initially defined, which comprises a barrel with an upper end portion, and a lip member as defined above, wherein the lip member is detachably or permanently attached to the upper end portion.

Furthermore, the object is achieved by the teatcup initially defined, which comprises a teatcup liner having a lip member as defined above. The lip member may thus form a separate part of the teatcup liner, or form an integrated part of the teatcup liner.

### BRIEF DESCRIPTION OF THE DRAWINGS

The present invention will now be explained more closely by means of a description of various embodiments and with reference to the drawings attached hereto.

FIG. 1 discloses a longitudinal section of a first embodiment of a teatcup according to the invention.

FIG. 2 discloses a longitudinal section of a lip member and a cartridge of the teatcup in FIG. 1.

FIG. 3 discloses a side view of the lip member of the teatcup in FIG. 1.

FIG. 4 discloses a sectional view of the lip member in FIG. 3.

FIG. 5 discloses a view from above of the lip member in FIG. 3.

FIG. 6 discloses a longitudinal section of a second embodiment of a teatcup according to the invention.

### DETAILED DESCRIPTION OF VARIOUS EMBODIMENTS OF THE INVENTION

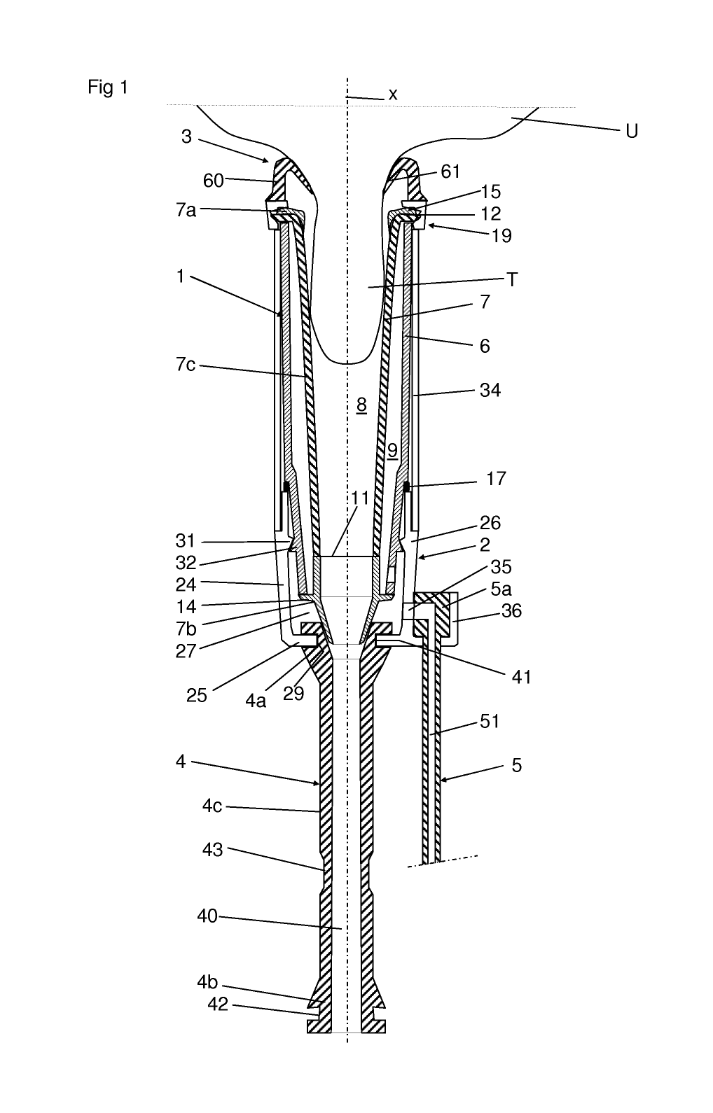

FIG. 1 discloses a teatcup attached to a teat T of an udder U of an animal to be milked according to a first embodiment. The teatcup comprises a cartridge 1 and a connector 2. The teatcup may also comprise a lip member 3, as a separate or integrated part of a teatcup liner. In addition, the teatcup may comprise or be connected to a milk conduit 4, such as a short milk conduit. Moreover, the teatcup may comprise or be connected to a pulse conduit 5.

A longitudinal centre axis x extends through and along the teatcup, i.e. the cartridge 1, the connector 2 and the lip member 3. The longitudinal centre axis x also extends through and along the milk conduit 4 when it is in a rest state.

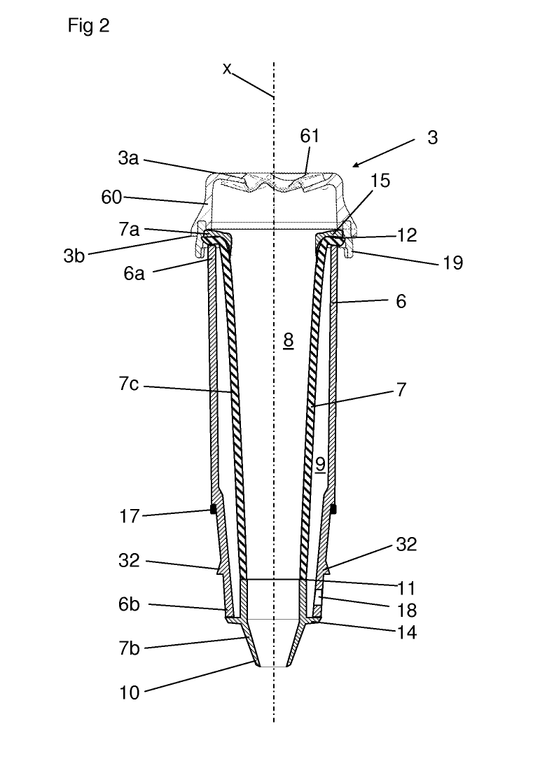

The cartridge 1, see also FIG. 2, comprises a sleeve 6 having an upper end 6a and a lower end 6b, and a barrel 7 mounted in the sleeve 6. In FIGS. 1 and 2, the cartridge is shown in a mounted state, i.e. the barrel 7 is mounted in the sleeve 6. The barrel 7 has or forms an inner space 8 for receiving the teat. A pulsation chamber 9 is provided or formed between an inner side of the sleeve 6 and an outer side of the barrel 7. The barrel 7 may form a separate or integrated part of the teatcup liner.

The barrel 7 comprises an upper end portion 7a located at the upper end 6a of the sleeve 6, a barrel portion 7c and a lower end portion 7b located at the lower end of the sleeve 6. The barrel portion 7c is an intermediate tubular portion provided between and adjoining the upper end portion 7a and the lower end portion 7b. The barrel portion 7c is the main part of the barrel 7 and is in contact with the teat of the animal during milking.

The lower end portion 7b extends from a position within the sleeve 6 away from and beyond the lower end 6b of the sleeve 6. The lower end portion 7b forms an end nozzle 10. The end nozzle 10 is the part of the lower end portion 7b that extends beyond the lower end 8b of the sleeve 8. The end nozzle 10 forms an outlet from the inner space 8.

The end nozzle 10 has a tapering external shape configured to be received in the milk conduit 4 for transporting the milk from the inner space 8 to the milk conduit 4. The end nozzle 10 also has a tapering internal shape forming a tapering outlet for the milk from the inner space 8 of the barrel 7.

The barrel portion 7c of the barrel 7 is made of a first material having a relatively high elasticity. The lower end portion 7b of the barrel 7 is made of a second material, which is different from the first material and has a different composition. The second material has a relatively low elasticity in comparison with the relatively high elasticity of the first material of the barrel portion 7c.

The first material may consist of or comprise rubber, black rubber, silicone rubber, elastic polymers, such as thermo-plastic elastomers, TPE, thermo-plastic vulcanisates, TPV, or any other suitable elastic material.

The second material may consist of or comprise a suitable polymer with low elasticity, such as polyeten, polypropene, etc.

The upper end portion 7a is made in a third material having a relatively low elasticity in comparison with the relatively high elasticity of the first material of the barrel portion 7c. The third material may be a material having similar or the same composition and/or properties as the second material of the lower end portion 7b.

The barrel portion 7c is attached to the lower end portion 7b by a lower permanent joint 11. Such a permanent joint 11 may be formed by a melt joint, a weld Joint or a chemical bonding between the first material and the second material.

The barrel portion 7c is also attached to the upper end portion 7a by an upper permanent joint 12. Such a permanent joint 12 may be formed by a melt joint, a weld joint or a chemical bonding between the first material and the third material.

The lower and/or upper permanent joints 11, 12 my be formed by melting of at least one of the first material and the second material at the permanent joint. The lower and/or upper permanent joints 11, 12 may also be obtained through vulcanisation.

Alternatively, the barrel portion 7c and the lower end portion 7b and/or the upper end portion 7a are made of the same material, for instance in one single piece, preferably through injection moulding.

The sleeve 6 is made of a fourth material having a relatively low elasticity. The fourth material may be a material having similar or the same composition and/or properties as the same material as the second material.

The lower end portion 7b of the barrel 7 comprises a lower engagement member 14, which engages the sleeve 6 in such a manner that the barrel portion 7c of the barrel 7 is maintained in a stretched state in the sleeve 6. The lower engagement member 14 comprises, or is formed as, an annular flange extending outwardly at least beyond an inner diameter of an end surface of the lower end 6b of the sleeve 6. The annular flange of the lower end portion 7b may extend radially or substantially radially outwardly with respect to the longitudinal centre axis x. The annular flange of the lower end portion 7b extends beyond and abuts the end surface of the lower end 6b of the sleeve 6.

The upper end portion 7a of the barrel 7 comprises an upper engagement member 15, which engages the sleeve 6 at the upper end 6a of the sleeve 6. The upper engagement member 15 comprises, or is formed as, an upper annular flange extending outwardly at least beyond an inner diameter of an end surface of the upper end 6a of the sleeve 6. The annular flange of the upper engagement member 15 may extend radially or substantially radially outwardly with respect to the longitudinal centre axis x. In the embodiment disclose, the annular flange of the upper engagement member 15 of the upper end portion 7a abuts an outwardly bent part of the first material of the barrel portion 7c, which in turn abuts the end surface of the upper end 6a of the sleeve 6.

The sleeve 6 comprises a sealing ring 17 extending around an outer surface of the sleeve 6. The sealing ring 17 is configured to engage a surface, especially an end surface, of the connector 2, as will be described below.

Moreover, the sleeve 6 comprises a hole 18 through the sleeve 6, or through the wall of the sleeve 6. The hole 18 permits a pulsating vacuum to be applied in the pulsation chamber 9. The hole 18 is provided between the sealing ring 17 and the lower end 6b of the sleeve 6.

The lip member 3 is in the first embodiment disclosed attached to the cartridge 1 and the upper end portion 7a of the barrel 7, as can be seen in FIG. 1, by means of a connection member 19. The lip member 3 may be detachably attached to the cartridge 1, or attached in connection with the mounting of the teatcup with the purpose of being permanently attached to the cartridge 1 and the upper end portion 7a. Thus, the connection member 19 is configured to permit snap connection of the lip member 3, but may not allow detachment of the lip member 3. In FIG. 2 the lip member 3 is shown in a detached state with respect to the barrel 7 and the cartridge 1. Alternatively, the lip member 3 may be detachably attached to the sleeve 6.

The connector 2 comprises a casing 24, which has a bottom wall 25 and a surrounding wall 26 having an inner surface. The casing 24 defines a connection space 27. The bottom wall 25 is plane or substantially plane.

The connector 2, or the casing 24, comprises an inlet opening 28 for the cartridge 1 to the connection space 27, and an outlet opening 29 for the milk conduit 4. The outlet opening 29 extends through the bottom wall 25 and is configured to receive and hold the milk conduit 4. In the first embodiment, the longitudinal centre axis x extends concentrically through the casing 24 and through the inlet opening 28 and the outlet opening 29, wherein the bottom wall 25 extends perpendicularly, or substantially perpendicularly to the longitudinal centre axis x.

The connector 2 is connected to the cartridge 1 by means of locking means. The locking means is provided on the inner surface of the surrounding wall 26. Corresponding locking means is provided on the outer side of the sleeve 6. The corresponding locking means is provided between the sealing ring 17 and the lower end 6b of the sleeve 6. The locking means may comprise on or more outer bayonet coupling parts 31 on the inner surface of the casing 24. The corresponding locking means may comprise one or more inner bayonet coupling parts 32 on the outer surface of the sleeve 6 of the cartridge 1. The outer bayonet coupling parts 31 and the inner bayonet coupling parts 32 form a bayonet coupling permitting secure locking of the cartridge 1 in the connector 2.

Furthermore, the connector 2 comprises an outer shell 34 extending beyond the inlet opening 28 of the casing 24. The outer shell 34 is tubular and attached to an end portion 24a of the casing 24. The purpose of the outer shell 34 is to protect the cartridge 1. The outer shell 34 may be made of a relatively rigid material, for instance as plastics or metal, such as stainless steel.

The casing 24 also comprises an aperture 35 extending through the casing 24 into the connection space 27. Furthermore, the connector 2 or the casing 24 comprises a holding member 36 configured to hold the pulse conduit 5 in a flow communication with the aperture 35 and the pulsating chamber 9 via the hole 18 for communicating a pulsating vacuum to the connection space 27 and to the pulsating chamber 9.

The milk conduit 4, or short milk conduit is tubular and comprises a first end portion 4a defining a first end, a second end portion 4b defining a second end, and a conduit portion 4c between the first end portion 4a and the second end portion 4b. The milk conduit 4 defines a milk channel 40 extending through the first end portion 4a, the conduit portion 4c and the second end portion 4b.

The first end of the milk conduit 4 may be defined or formed by a plane, or substantially plane, end surface from which the milk channel 40 extends.

The first end portion 4a of the milk conduit 4 has an external tapering shape from the first end to the conduit portion 4c. The milk conduit 4 thus has a greater outer diameter at the first end compared to the outer diameter at the conduit portion 4c.

The first end portion 4a is configured to be received in the outlet opening 29 extending through the bottom wall 25 of the connector 2 of the teatcup. The first end portion 4a comprises a first circumferential groove 41 configured to engage the bottom wall 25, see FIG. 1. The first circumferential groove 41 is positioned at a distance from the first end and at a distance from the conduit portion 4c.

The milk channel 40 of the first end portion 4a has an internal tapering shape from the first end towards the milk channel 40 of the conduit portion 4c.

The second end portion 4b comprises a second circumferential groove 42, which is configured to be received in any suitable milk-receiving member or milk-collecting member, such as a claw, not disclosed. The second circumferential groove 42 is positioned at a distance from the second end and at a distance from the conduit portion 4c. Also the second end portion 4b has an external tapering shape from the second end to the conduit portion 4c.

The milk conduit 4 is made of a hose material having a relatively high elasticity in the order of the elasticity of the first material of the barrel portion. For instance, the milk conduit 4 may be manufactured of natural rubber, black rubber, silicone rubber or thermo-plastic elastomers, TPE, thermo-plastic vulcanisates, TPV. The conduit portion 4c comprises an bending area 43 having a locally decreased outer diameter, and thus a locally increased elasticity to provide a predetermined area for bending of the milk conduit 4.

Also the pulse conduit 5 may be made of a hose material having a relatively high elasticity, possibly the same hose material as the material of the milk conduit 4. The pulse conduit 5 has a attachment end portion 5a to be engaged by the holding member 36. The pulse conduit 5 defines or encloses a pulse channel 51 extending along the pulse conduit 5 through the attachment end portion 5a. The attachment end portion 5a defines an opening of the pulse channel 51. When the pulse conduit 5 is engaged by the holding member 36, the opening is positioned opposite to the opening 35 through the casing 24.

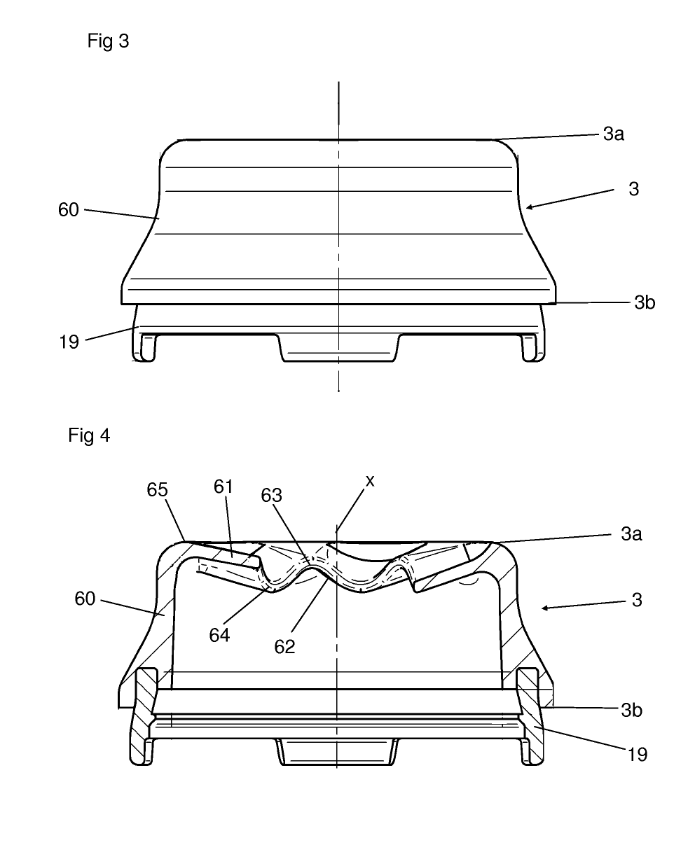

The lip member 3, see FIGS. 2 to 5, comprises a first end 3a, configured to be turned towards an udder of an animal to be milked, and a second end 3b, configured to be turned away from the udder U. The longitudinal centre axis x extends through the first end 3a and through the second end 3b.

The lip member 3 also comprises an annular base 60 extending around the longitudinal centre axis x, and a lip 61 comprising a lip edge 62 defining an opening for receiving the teat T of the animal to be milked. 12. The annular base 60 has a tubular shape between the first end 3a and the second end 3b, and extends from the first end 3a towards the second end 3b. The annular base 60 is connected to the connection member 19 extending beyond the annular base 60 to the second end 3b. The lip 61 extends from the tubular annular base 60 at the first end 3a.

In FIGS. 2 to 5, the lip member 3 is shown in a rest state, whereas the lip member 3 in FIG. 1 is shown in an active state in which the lip 60 surrounds and abut the teat T. In the rest state of the lip member 3, the lip 61 thus extends inwardly from the annular base 60 towards the longitudinal centre axis x to the lip edge 62.

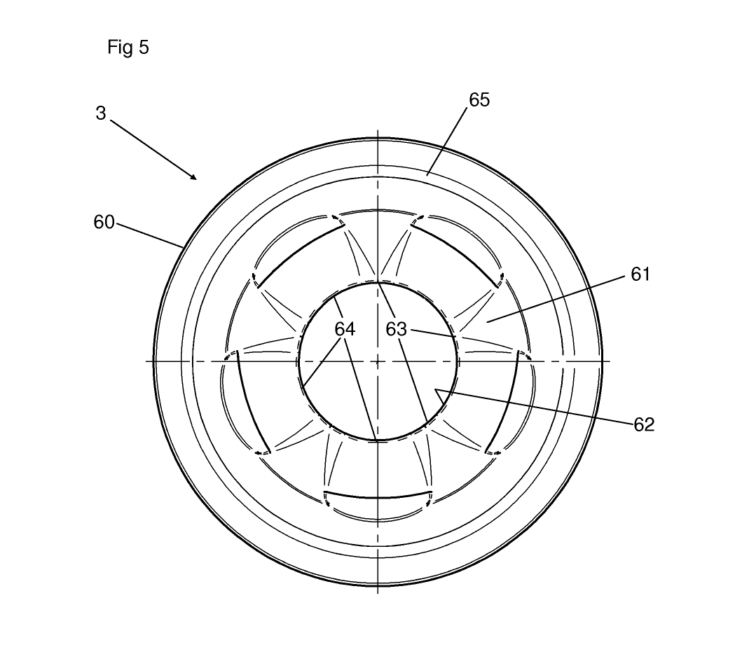

The lip 61 has an oscillating shape, or wave shape, with a plurality of oscillations seen radially from the longitudinal centre axis x. Each oscillation comprises a peak portion 63 and valley portion 64. In the first embodiment, the oscillating shape comprises five oscillations, i.e. five peak portions 63 and five valley portions 64. As can be seen in FIGS. 4 and 5, the valley portions 64 are more extended along the lip edge 62 than the peak portions 63.

The oscillations, i.e. the peak portions 63 and the valley portions 64, extend along a length from lip edge 62 to a position at the annular base 60. The lip 61 has a thickness. In the embodiments disclosed, the thickness is constant, or substantially constant. Especially, the thickness is constant, or substantially constant, along the length of the oscillations.

It is to be noted that the number of oscillation may be another than five, for instance four oscillations, six oscillations or seven oscillations.

The amplitude of the oscillations of the lip 61 may decrease from the lip edge 62 towards the annular base 60. At the annular base 60, the amplitude of the oscillations of the lip 61 may be zero. However, It is also possible to let the oscillations continue, with a constant amplitude or with a decreasing amplitude, to the annular base

In the first embodiment, each peak portion 63 and each valley portion 64 extend in a radial direction, when the peak portions and the valley portions 63 are seen along the longitudinal centre axis x. It is to be noted that the peak portions 63 and the valley portions 64, alternatively, may be inclined in relation to the radial direction when seen along the longitudinal centre axis x, be curved in relation to the radial direction seen along the longitudinal centre axis x.

The lip member 3 comprises an annular end surface 65 provided on the annular base 60 at the first end 3a, see FIGS. 5 and 4. The annular end surface 65 is preferably plane, or substantially plane. Preferably, the annular end surface may be provided in a plane being perpendicular to the longitudinal centre axis x.

As can be seen in FIG. 4, the lip 61 slopes from the annular base 60, or from the annular end surface 65, towards the second end 3b in the rest state. Thus, the lip 61 extends from the annular base 60 from a position at the annular end surface, i.e. at the first end 3a, to a position between the first end 3a and the second end 3b. Thus, the lip edge 62 may be located at a position between the first end 3a and the second end 3b at least in the rest state. Advantageously, each peak portion 64 is located between the first end 3a and the second end 3b at least in the rest state. Thanks to this configuration, the annular end surface will provide the end plane of the lip member 3, i.e. no part of the lip member 3 will project beyond the annular end surface enabling the teatcup to be positioned on a support surface of a cleaning device.

The lip 61 and the annular base 60 are manufactured of thermo-plastic elastomers, TPE, or thermo-plastic vulcanisate, TPV. The lip 61 and the annular base 60 are thus also made of a relatively elastic material, possibly a material having similar or the same composition and/or properties as the first material of the barrel portion 7c.

The thermo-plastic vulcanisates, TPV, may comprise a thermo-plastic continuous phase and a cross-linked rubber discontinuous phase.

The connection member 19 may be manufactured of the above-mentioned second material that may consist of or comprise a suitable polymer with low elasticity, such as polyeten, polypropene, etc.

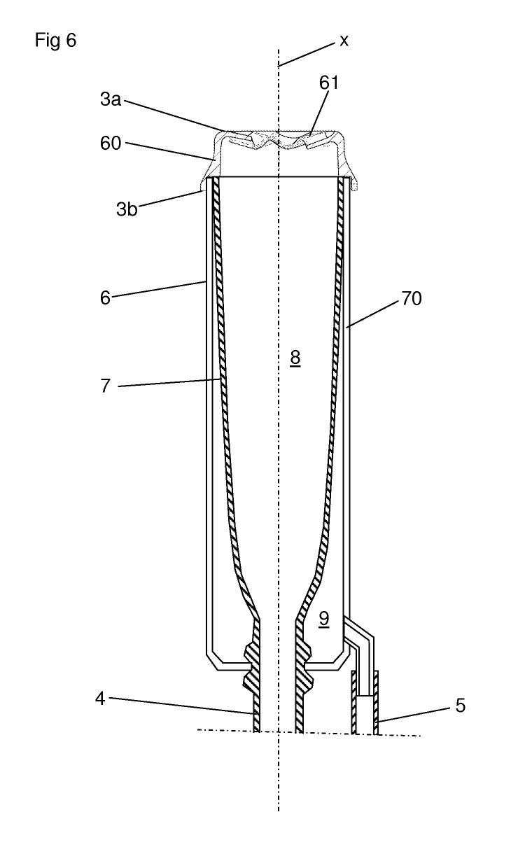

FIG. 6 discloses a second embodiment, which differs from the first embodiment in that the lip member 3, which is a part of the teatcup liner, is permanently joined to the upper end portion 7a, or being manufactured in one single piece with the upper end portion 7a or with the barrel 7. The teatcup liner with the lip member 3 is not associated with a cartridge, but introduced in a shell 70 to form a teatcup of a more conventional design except for the configuration of the lip member 3 and the lip 61. The lip 61 and the annular base 60 have the same design as in the first embodiment.

The present invention is not limited to the embodiments disclosed but may be varied and modified within the scope of the following claims.

1-15. (canceled)

16. A lip member of a teatcup liner, the lip member (3) comprising:
a first end (3a) that in use is turned towards an udder (U) of an animal to be milked;
a second end (3b) that in use is turned away from the udder (U);
a longitudinal center axis (x) extending through the first end (3a) and through the second end (3b);
an annular base (60) extending around the longitudinal center axis (x);
an annular end surface (65) provided at the first end (3a) on an end of the annular base (60); and
a lip (61) extending from the annular end surface (65) and terminating with a lip edge (62) that defines an opening for receiving a teat (T) of the animal to be milked,
wherein, in at least a rest state, the lip extends inwardly towards the longitudinal center axis (x) and downwardly from the annular end surface (65) toward the second end (3b) with no part of the lip (61) projecting beyond the annular end surface (65) such that the annular end surface (65) defines an uppermost end of the lip member (3), and
wherein the lip (61) has an oscillating shape with a plurality of oscillations seen radially from the longitudinal center axis (x), each oscillation comprising a peak portion (63) and valley portion (64).

17. The lip member according to claim 16, wherein the oscillating shape comprises at least four of the oscillations and at most seven of the oscillations.

18. The lip member according to claim 16, wherein an amplitude of each oscillations decreases from the lip edge (61) towards the annular base (60).

19. The lip member according to claim 18, wherein the amplitude of the oscillations of the lip (61) is non-zero at the annular base (60).

20. The lip member according to claim 18, wherein the oscillations of the lip (61) continue toward the annular base (60) and is zero at the annular base (60).

21. The lip member according to claim 18, wherein the amplitude of the oscillations of the lip (61) continue, with a constant amplitude, to the annular base (60).

22. The lip member according to claim 16, wherein each peak portion (63) and each valley portion (64) extend in a radial direction when seen along the longitudinal center axis (x).

23. The lip member according to claim 16, wherein the annular base (60) extends from the first end (3a) towards the second end (3b).

24. The lip member according to claim 16, wherein the lip member (3) comprises an annular end surface (65) provided on the annular base (60) at the first end (3a).

25. The lip member according to claim 22, wherein the annular end surface (65) is a plane.

26. The lip member according to claim 16, wherein the lip (61) extends, in the rest state, from the annular base (60) with the lip edge (62) located at a position between the first end (3a) and the second end (3b).

27. The lip member according to claim 26, wherein, in an active state during milking of the animal, the lip edge (62) is in tight abutment against the teat.

28. The lip member according to claim 16, wherein, at least in the rest state, each peak portion (64) is located between the first end (3a) and the second end (3b).

29. The lip member according to claim 16, wherein the annular base (60) has a tubular shape between the first end (3a) and the second end (3b).

30. The lip member according to claim 16, wherein the lip (61) and the annular base are manufactured of one of the group consisting of thermo-plastic elastomers (TPE) and thermo-plastic vulcanisate (TPV).

31. The lip member according to claim 17, wherein the oscillating shape comprises exactly five oscillations.

32. The lip member according to claim 16, in combination with a teatcup liner comprising a barrel (7) with an upper end portion (7a), wherein the lip member (3) is attached to the upper end portion (7a).

33. The lip member according to claim 16, in combination with a teatcup comprising a teatcup liner, the teatcup liner comprising a barrel (7) with an upper end portion (7a), wherein the lip member (3) is attached to the upper end portion (7a).
